(19) United States
(12) Patent Application Publication
(10) Pub. No.: US 2007/0216154 A1
(43) Pub. Date: Sep. 20, 2007

(54) Mounting system and methods for attaching accessory components

(76) Inventor: Charles L. Casagrande, Bradenton, FL (US)

Correspondence Address: VALAUSKAS & PINE LLC, Suite 4130, One North Wacker Drive, Chicago, IL, 60606, US

(21) Appl. No.: 11/713,569

(22) Filed: Mar. 2, 2007

Related U.S. Application Data
(60) Provisional application No. 60/779,195, filed on Mar. 3, 2006.
(60) Provisional application No. 60/899,202, filed on Feb. 2, 2007.

(51) Int. Cl. B42D 15/00

(52) U.S. Cl. 283/61

(57) ABSTRACT

A mounting system for attaching components to surfaces without compromising, but instead maintaining, the integrity of the mounting surface. The mounting system includes a vacuum device and component, or water vessel accessory, such that it is easily movable, can withstand or support heavy loads, does not require permanent alteration of the mounting surface by drilling holes or tapping screws and does not require hardware to be affixed to the surface.

### PRIORITY NOTICE

This Non-Provisional U.S. patent application claims the benefit of Provisional U.S. Patent Application Ser. No. 60/779,195 filed Mar. 3, 2006 and Provisional U.S. Patent Application Ser. No. 60/899,202 filed Feb. 2, 2007.

### FIELD OF THE INVENTION

The present invention relates to a system by which components may be attached to surfaces. More particularly, the present invention is directed to a system by which components may be attached to surfaces without compromising, but instead maintaining the integrity of a mounting surface.

The system is useful in mounting components in a variety of contexts and environments including surfaces of vessels, vehicles, and residential and commercial structures.

### BACKGROUND OF THE INVENTION

For purposes of this application, the present invention is discussed in reference to mounting accessories to the surface of water vessels, but the present invention is applicable to attaching any component to any surface.

There are a variety of accessories used on water vessels. Water vessels include, for example, power boat, yacht, caravel, pontoon, rowboat, canoe, sailboat, jet ski dredge, catamaran, ferry, submarine, and tugboat, to name a few.

Types of accessories used on water vessels include electronic, recreational, and craft. Electronic accessories include digital devices, portable devices, such as audio players, vhf and satellite radio, global positioning system (GPS), fish and depth finders, camera and video mounts, safety items such as Emergency Position Indicating Radio Beacon (EPIRB), and personal GPS, radar, etc. Recreational accessories include dive tank, fishing rod and reel, tackle box, spear gun, tow bar, ice chest, fillet table, cutting board, trolling motor, gimbal mounts, etc. Craft accessories include boarding ladder, sea chair, light, bumper, buoy, marker buoy, eyelet, carabiner, cleat, handle, clamps and straps, which can be used to hold gaffs, nets and other poles, for example, etc.

Accessories are attached to the vessel, typically using adhesives or hardware such as screws, nails, rivets, or bolts that require drilling holes in the vessel to allow for secure attachment of accessories. This disrupts the surface of the vessel. With the loss of the surface integrity, the surface can be weakened.

A demand therefore exists for a mounting system for that is easily movable, can withstand or support heavy loads, does not require permanent alteration of the mounting surface by using adhesives, drilling holes or tapping screws and does not require hardware to be affixed to the surface. With respect to a marine environment, a demand exists for a mounting system for water vessel accessories that is easily movable, can withstand or support heavy loads, does not require permanent alteration of the vessel by using adhesives, drilling holes or tapping screws and does not require hardware to be affixed to the water vessel.

### SUMMARY OF THE INVENTION

The mounting systems of the present invention allow components to be removeably attached as needed to surfaces without compromising, but instead maintaining, the integrity of the mounting surface. The mounting systems of the present invention allow components, otherwise referred to herein as accessories, to be attached to a water vessel surface. The surface of a water vessel can be any surface, for example deck, coach-roof, sole, deck head, bulkhead, bow, stern, starboard, port, hull, keel, transom, cabin trunk, console, cockpit, etc.

The present invention can utilize a vacuum device including a vacuum pad with a vacuum pump. One type of vacuum device is available from Wood's Power-Grip Co., Inc. of Laurel, Mont. According to the present invention, the vacuum pad can be of any type such as standard suction cup, lever cup, snap hook cup or vacuum cup, and can be of any shape, for example, cup or shield and can further be of any size. The vacuum device is quickly and easily attachable and detachable to mounting surfaces including surfaces underwater.

An object of the present invention is to include a check valve. A check valve allows the vacuum device to be re-pumped without loss of remaining vacuum. It is also an object of the present invention to include an automatic pump to monitor the vacuum level of the vacuum device. The automatic pump acts as a regulator such that it turns on to increase the vacuum level of the device if the vacuum falls below a pre-determined level.

A novel aspect of the present invention is a mounting system that includes a securing element that attaches an accessory to the vacuum device. Securing elements include, for example, fastener, adhesive, housing, hardware, clamp, clasp, clip, pin, peg, snap-fit projections, hook-and-loop fastener, and twist-and-lock nodules.

The securing element of the present invention can further include a receiving element. The receiving element is any size, shape, or dimension in order to allow attachment of an accessory to the vacuum device. Likewise, the receiving element can be located, or positioned, anywhere on the securing element. Receiving elements include, for example, apertures, slots and receptacles. The securing element allows for various mounting system configurations. Securing elements can be connected to one another, and additionally allow for more surface area to attach components and/or mounting systems. It is further contemplated that the receiving elements can be configured for a universal connection for rapid attachment and detachment of components, for example, snap-fit connection, quick-connection and twist-and-lock connection.

It is contemplated that some embodiments of the present invention include a support element. The support element, for example a buttress, bracket, rope, plate, rod, can be of any size and/or shape to attach an accessory to the vacuum device. The support element allows for various mounting system configurations. Support elements can be connected to one another, and additionally allow for more surface area to attach components and/or mounting systems. In addition, support elements assist to stabilize and/or distribute the load of the component, thereby alleviating stress on the mounting system and mitigating separation of the pad from the mounting surface.

The support element may further include a connecting element for attachment to the securing element. The connecting element can be any size, shape or configuration for engaging with the securing element. Examples of connecting elements include, for example, apertures, slots and receptacles. It is also contemplated that connecting elements can include fastener, adhesive, hardware, clamp, clasp, clip, pin, peg, snap-fit projections, hook-and-loop fastener, and twist-and-lock nodules.

Accordingly, it will be recognized that an object of the present invention is to provide a mounting system that is of simple construction and design and can be easily employed with highly reliable results.

It is an object of the present invention to provide a mounting system that allows the safe and secure attachment of a variety of components to mounting surfaces. The present invention provides a mounting system to attach components to surfaces without altering, or compromising, the mounting surface, for example by the use of adhesives or hardware, i.e., no residue, no drilling holes or tapping screws into the surface.

It is another object of the present invention to provide a mounting system that allows an accessory to be quickly and easily attached and detached to any surface. The component is removable attached to the vacuum device and may include a universal connection for rapid attachment and detachment of the component to the vacuum device.

Current mounting systems including lever devices are manufactured from metal such that they undergo corrosion and drip rust under environmental elements. It is another object of the present invention to provide a mounting system that is durable such as manufactured from marine grade stainless steel, powder-coated aluminum, rubber or plastic to withstand environmental elements, for example, saltwater, freshwater, extreme temperatures, rough seas to name a few.

It is another object of the present invention to provide a mounting system that withstands heavy loads. Depending on the size of the pad, the present invention can support loads of two hundred pounds or more and multiple times that amount underwater. For example, the mounting system of the present invention can be used with an underwater lift bag, which is a non-porous bag a diver inflates with air from a dive tank to lift sunken boats and other items from the sea floor.

Yet another object of the present invention is to provide a mounting system that can adhere not only to smooth mounting surfaces, but also some non-skid or rough mounting surfaces. The present invention can adhere to some non-skid surfaces with the use of a water-based gel that has the viscosity to fill dips, valleys, gaps, or irregularities between the vacuum device and rough surface.

Typically, vacuum pads of vacuum devices are made from a black rubber material, which easily marks or scuffs a mounting surface. It is an object of the present invention to provide a non-marking mounting system such that the vacuum pad does not mark or scuff the mounting surface. For example, a pad made from white or grey rubber material alleviates marks or scuffs on the mounting surface.

It is another object of the present invention to provide a pad that maintains the vacuum between the pad and the mounting surface. A pad made from a light colored material such as white or grey rubber minimizes the expansion a black rubber pad may experience in extreme heat and likewise the air and gases between the pad and mounting surface.

Another object of the present invention is to provide a mounting system that can be operated by remote control.

Another object of the present invention is to provide a mounting system that can be assembled from readily available components such that the mounting system accommodates various sizes and dimensions of accessories.

Another object of the present invention is to provide a mounting system wherein any part thereof is made from a reflective material, iridescent material or a glow-in-the-dark material.

Examples of components that can be attached to a water vessel mounting surface with the mounting system of the present invention include electronic, recreational, and craft accessories, for example, tackle box, lights, dive tanks, radar, portable electronic device, gimbal mount, marker buoy, cleat, rod holder. It is also contemplated that other components such as pegboard fittings such as hooks, shelf bars, tool holders, label holders, and racks can be attached to a water vessel mounting surface with the mounting system of the present invention.

The present invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to limit the invention, where like designations denote like elements, and in which:

FIG. 1 illustrates a vacuum device of a mounting system according to the present invention;

FIG. 2 illustrates an embodiment of a securing element according to the present invention;

FIG. 3 illustrates another embodiment of a support element according to the present invention;

FIG. 4 illustrates another embodiment of a support element according to the present invention;

FIG. 5 illustrates another embodiment of a support element according to the present invention;

FIG. 6 illustrates another embodiment of a support element according to the present invention;

FIG. 7 illustrates another embodiment of a support element according to the present invention;

FIG. 8 illustrates another embodiment of a support element according to the present invention;

FIG. 9A graphically illustrates how the support element of FIG. 8 helps bear the load of an attached component;

FIG. 9B graphically illustrates how the support element of FIG. 8 helps bear the load of an attached component;

FIG. 10 illustrates a mounting system according to the present invention;

FIG. 11 illustrates another embodiment of a mounting system according to the present invention;

FIG. 12 illustrates another embodiment of a mounting system according to the present invention;

FIG. 13 illustrates another embodiment of a mounting system according to the present invention;

FIG. 14 illustrates another embodiment of a mounting system according to the present invention;

FIG. 15 illustrates another embodiment of a mounting system according to the present invention;

FIG. 16 illustrates another embodiment of amounting system according to the present invention;

FIG. 17 illustrates another embodiment of a mounting system according to the present invention;

FIG. 18 illustrates another embodiment of a mounting system according to the present invention;

FIG. 19 illustrates another embodiment of a mounting system according to the present invention;

FIG. 20 illustrates another embodiment of a mounting system according to the present invention;

FIG. 21 illustrates another embodiment of a mounting system according to the present invention;

FIG. 22 illustrates another embodiment of a mounting system according to the present invention;

FIG. 23 illustrates another embodiment of a mounting system according to the present invention;

FIG. 24 illustrates another embodiment of a mounting system according to the present invention;

FIG. 25 illustrates another embodiment of a mounting system according to the present invention;

FIG. 26 illustrates another embodiment of a mounting system according to the present invention;

FIG. 27 illustrates another embodiment of a mounting system according to the present invention;

FIG. 28 illustrates another embodiment of a mounting system according to the present invention; and

FIG. 29 illustrates another embodiment of a mounting system according to the present invention.

### DETAILED DESCRIPTION OF EMBODIMENTS OF THE INVENTION

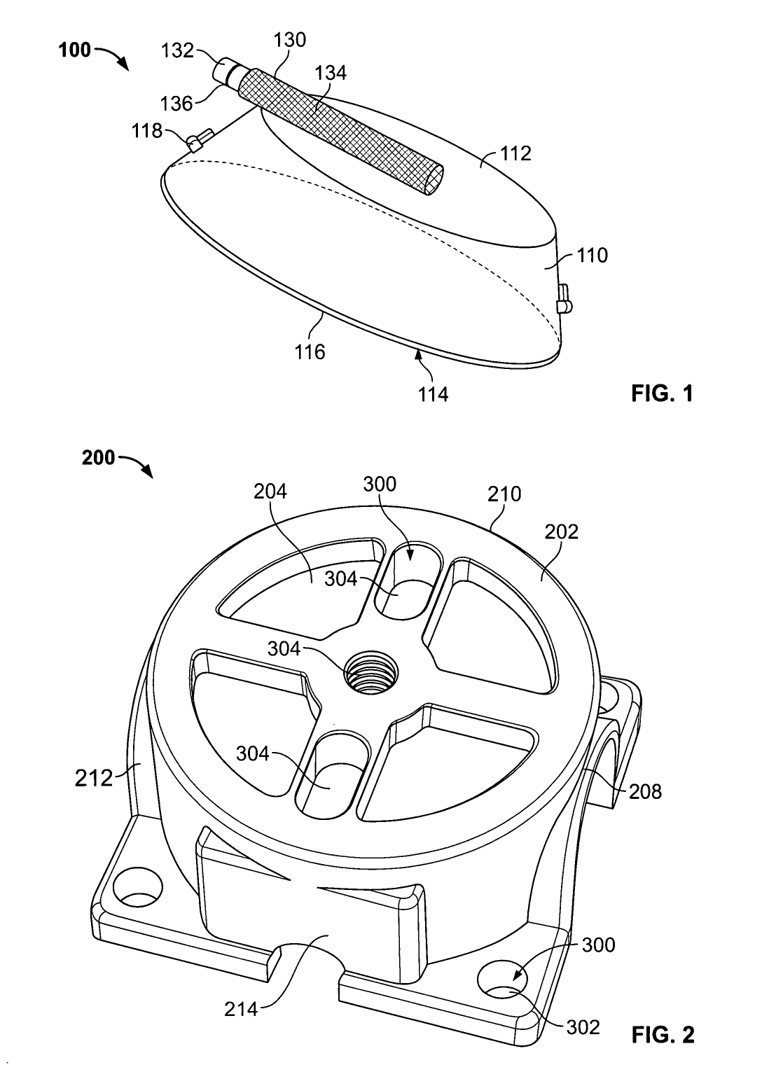

FIG. 1 illustrates a vacuum device 100 of a mounting system according to the present invention. The present invention includes a vacuum device 100 including a vacuum pad 110 and vacuum pump 130. Pad 110 includes a top face 112 and vacuum face 114 with an edge 116. Edge 116 forms a vacuum seal with the mounting surface of a water vessel. The top face 112 includes release tabs 118. Tabs 118 are t-shaped ribs to add rigidity such that in warmer temperatures the tabs 118 do not become flexible and prevent release of the vacuum device 100. Pad 110 can be any color and material, although a color and material that does not scuff the mounting surface is preferable. The pad can be a reflective or glow-in-the-dark material so that it can be seen in dark atmospheres and under water.

The pump 130 includes a plunger 132, cylinder 134, and an indicator 136. The indicator 136 can be red, yellow or any color that is easily seen. Additionally, the indicator 136 can be a reflective or glow-in-the-dark material so that it can be seen in dark atmospheres and under water.

As shown in FIG. 1, the plunger 132 of pump 130 is positioned within the cylinder 134 and placed on the top face 112 of pad 110. The vacuum face 114 of pad 110 grips, or adheres, to a mounting surface of a water vessel. The plunger 132 is pushed into the cylinder 134 such that air, gas, and water are removed from between the vacuum face 114 of the pad 110 and mounting surface. This creates a vacuum such that edge 116 and vacuum face 114 of pad 110 grips the surface. A vacuum is a space from which all matter including air and any gas, is totally removed. A vacuum exists whenever the pressure within the space is less than the pressure that surrounds it.

The indicator 136 on plunger 132 conveys the securement level of the attachment between the vacuum device 100 and mounting surface. When vacuum device 100 is securely attached, the plunger 132 stops moving within the cylinder 134 and the indicator 136 is hidden within cylinder 134. If the indicator 136 is visible, or positioned outside cylinder 134, the vacuum between the pad 110 and mounting surface may be insufficient for the load of the accessory, which may mean the pad 110 is separating from the surface.

A check valve allows the vacuum device to be re-pumped without loss of remaining vacuum. Likewise, an automatic pump can be used to increase the vacuum level of the vacuum device if it falls below a pre-determined level.

To release the vacuum and remove the vacuum device 100, release tabs 118 on the top face 102 of pad 100 are lifted away from the mounting surface. In other embodiments, a valve stem can be activated to release the vacuum device. Additionally, a twist button with a course thread located on the top face of the pad can be used to release the vacuum device.

Certain embodiments of the present invention include securing elements 200 that can be connected to the vacuum device 100 or connected to another securing element 200. Certain embodiments of securing element 200 include a receiving element 300. Securing element 200 can be of any shape, size or configuration. Securing element 200 can further be connected to one another, allowing for various configurations to attach components 50.

As shown in FIG. 2, securing element 200 is a housing 202. Housing 202 can integrate the vacuum pad 110 and vacuum pump 130 of the vacuum device 100. Housing 202 has a top side 204, bottom side 206, first side 208, second side 210, third side 212, and pump side 214. It is contemplated that securing element 200 can be of any size and/or shape and positioned anywhere to accommodate integration of the pad 110 with pump 130 while allowing for the attachment of an accessory and likewise to a surface of a water vessel.

As shown in FIG. 2, securing element 200 includes receiving elements 300, here housing apertures 302 and attachment apertures 304. Housing apertures 302 and attachment apertures 304 are shown on top side 204 of housing 202, but it is contemplated that housing apertures 302 and attachment apertures 304 can be located on any side 206, 208, 210, 212, 214 of the housing 202. The housing apertures 302 and attachment apertures 304 can be holes, slots, or any other configuration to accommodate different dimensions of various manufacturers' accessories. Housing 202 can be made from a variety of materials, including marine grade stainless steel, powder-coated aluminum, rubber or plastic

Attachment apertures 304 of housing 202 allow for two or more vacuum devices 100 to be assembled onto one another, such as side-to-side or back-to back. For example, a back-to-back configuration can be used with a fillet table or cooler.

Certain embodiments of the present invention include a support element 400. The support element 400 can be connected to the vacuum device 100 securing element 200, or receiving element 300. Support element 400 can be of any shape, size or configuration. The support element can bear the load of the water vessel accessory alleviating stress on the vacuum device and/or can allow for various mounting system configurations. Support elements 400 also assist in preventing the vacuum pad from separating from the mounting surface.

It is also contemplated that the present invention includes embodiments with a vacuum pad 100 and a support element 400, without the requirement for a vacuum pump. The support element 400 assists the vacuum pad 100 in maintaining a vacuum with the mounting surface. Components 50 can then be attached to the support element 400. Other embodiments can further include a securing element 200 to which components 50 can be attached, and likewise a securing element 200 with receiving elements 300 to which components 50 are attached.

Support elements 400 can further be connected to one another, allowing for more area to attach components 50. Additionally, a support element 400 can include a connecting element 500. Connecting elements 500 allow attachment to one or more vacuum devices 100, one or more securing elements 200, other support elements 400, and components 50. For example, a support element 400 can include connecting elements 500 down a side wall to allow for vertical attachment of components 50, such as a gimbal that hangs over a boat ledge.

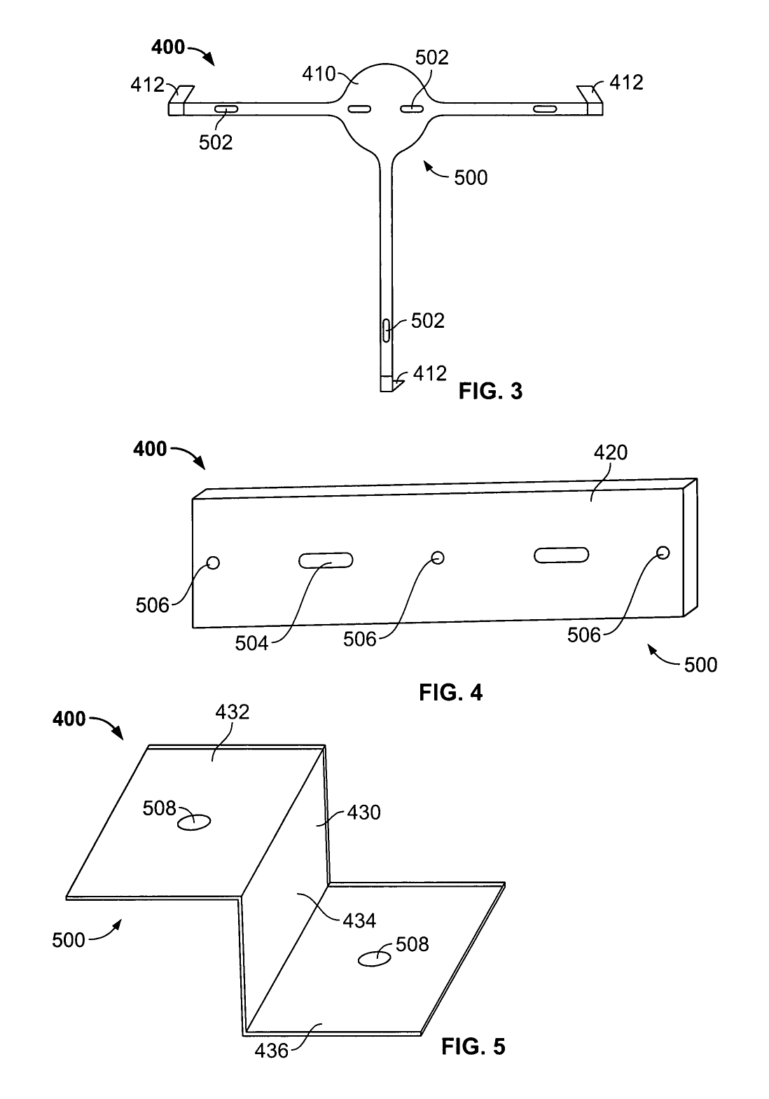

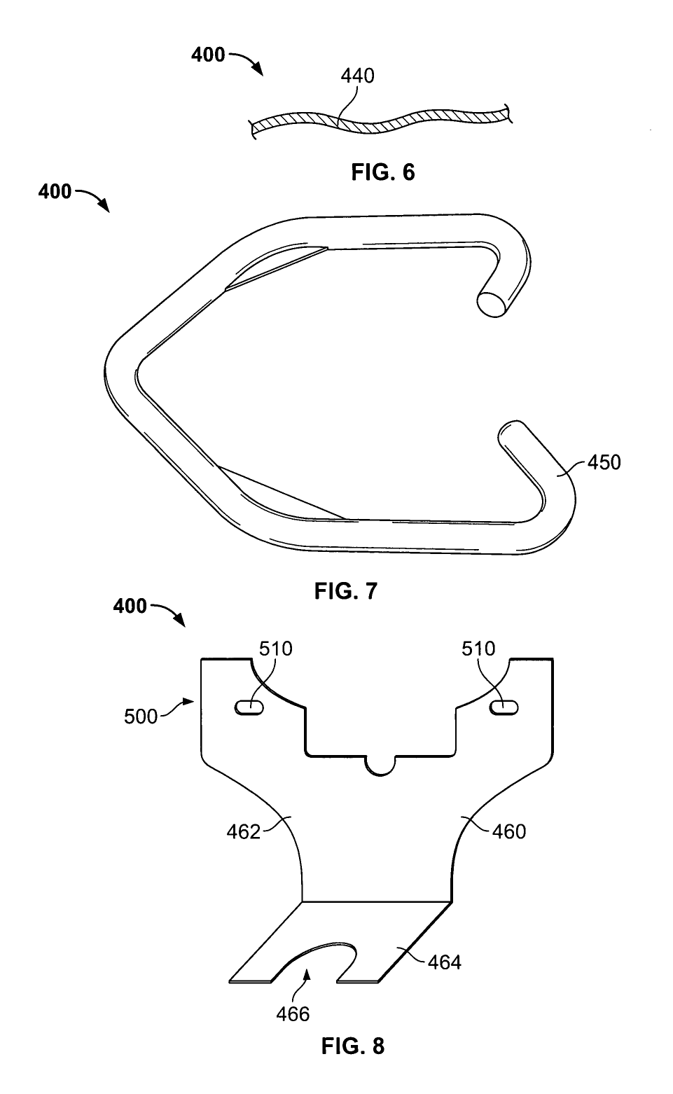

FIGS. 3 through 8 illustrate embodiments of support elements 400, some with connecting elements 500. FIG. 3 is a T-shaped brace 410 with slotted connecting elements 502 and legs 412. FIG. 4 is a plate 420. Plate 420 includes connecting elements 500; here plate openings 504 and component openings 506. FIG. 5 is an S-shaped bracket 430. Bracket 430 includes a first form 432 connected to a second form 434, which in turn is connected to a third form 436. The forms 432, 434, 436 are connected at ninety degrees from one another, but any angle is contemplated. First form 432 and third form 436 include form openings 508. FIG. 6 is a rope 440 and FIG. 7 is a handle 450.

FIG. 8 is a buttress 460. Buttress 460 includes a flat panel 462 connected to an angled panel 464. The flat panel 462 further includes panel openings 510. Once attached to a vacuum device 100, the angled panel 464 clears the pad vacuum 110 and bears the load of the water vessel component alleviating stress on the vacuum device 100 such that the pad 110 does not separate from the mounting surface of the water vessel. Arch 466 allows access to tabs 118 of pad 110 in order to release the vacuum device 100. Various sizes and shapes of support elements 400 are contemplated to support the load of the water vessel accessory, for example, a bowl shape, upside dome, or octagonal legs extending 360° around the pad.

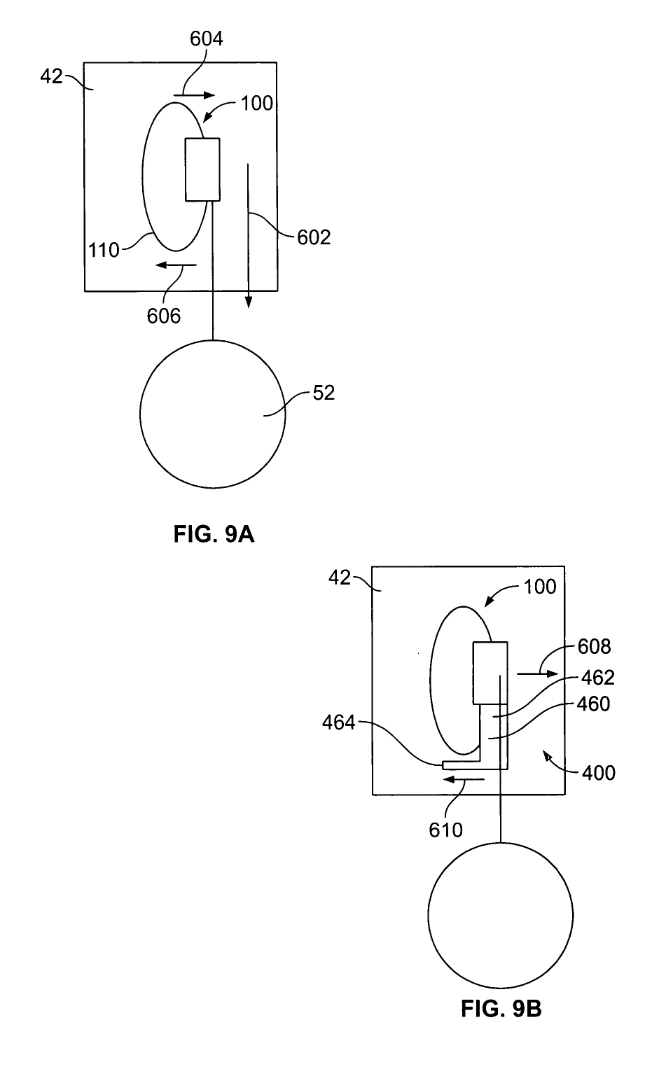

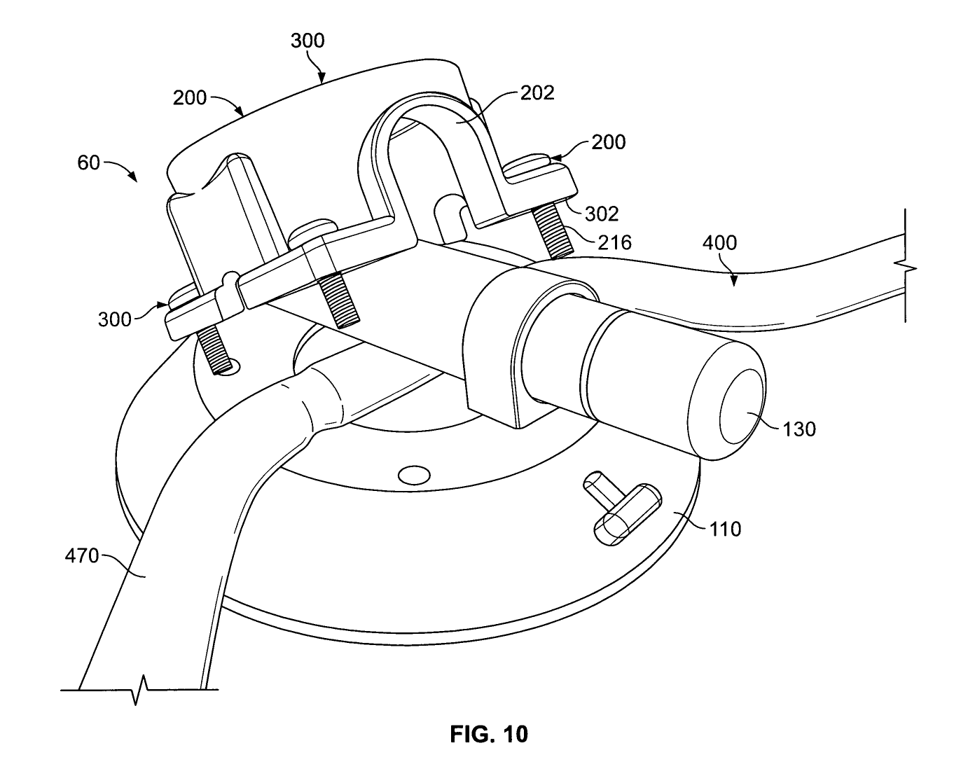

FIGS. 9A and 9B graphically illustrate how the support element 400 of FIG. 8 helps bear the load of an attached component alleviating stress on the vacuum device 100. FIG. 9A illustrates the vacuum device 100 before a support element 400 is connected. As can be seen in FIG. 9A, a large component 52, for example a weighted buoy, creates a downward force on the vacuum device 100 illustrated by arrow 602. With respect to the mounting surface 42, this downward force 602 causes pad 110 to pull at the top as illustrated by arrow 604 and push at the bottom as illustrated by arrow 606.

After support element 400 is added to the vacuum device 100, forces are re-distributed. As shown in FIG. 9B, the buttress 460 of FIG. 8 is connected to the vacuum device 100. The buttress 460 acts as a pivot such that downward force illustrated by arrow 602 in FIG. 9A is now partially supported by angled panel 464 of buttress 460 such that a force pulls at the center of the vacuum device 100 as illustrated by arrow 608 in FIG. 9B. With respect to the mounting surface 42, while the force 608 pulls at the center of the vacuum device 100, a force also pushes on the buttress 460 as illustrated by arrow 610. Thus, the buttress 460 eliminates the pull at the top of the pad as illustrated by arrow 604 in FIG. 9A, thereby mitigating separation of the pad 110 from the mounting surface 42.

FIG. 10 illustrates a mounting system 60 comprising a vacuum device 100 with a securing element 200, a securing element 200 with receiving elements 300, and a support element 400. As shown in FIG. 10, vacuum pad 110 and vacuum pump 130 are integrated by housing 202. Screws 216 engage with housing apertures 302 to secure the pad 110 and pump 130. Bendable support elements 470 are further secured by housing 202. Bendable support elements 470 are flexible to accommodate any accessory and additionally stabilize to the accessory attached to the mounting system 60. Accessory 50 can be secured to attachment apertures 304 of housing 202 and/or be supported by bendable support elements 470. Bendable support elements 470 can likewise act as a lanyard from which accessories or other items can be secured or suspended.

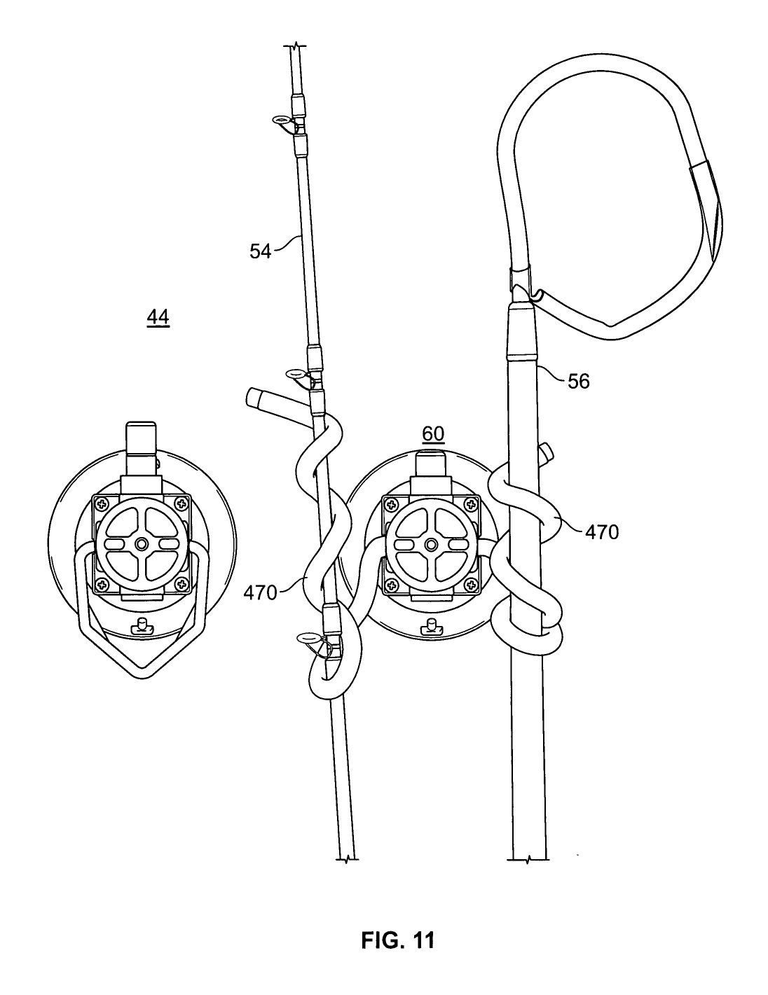

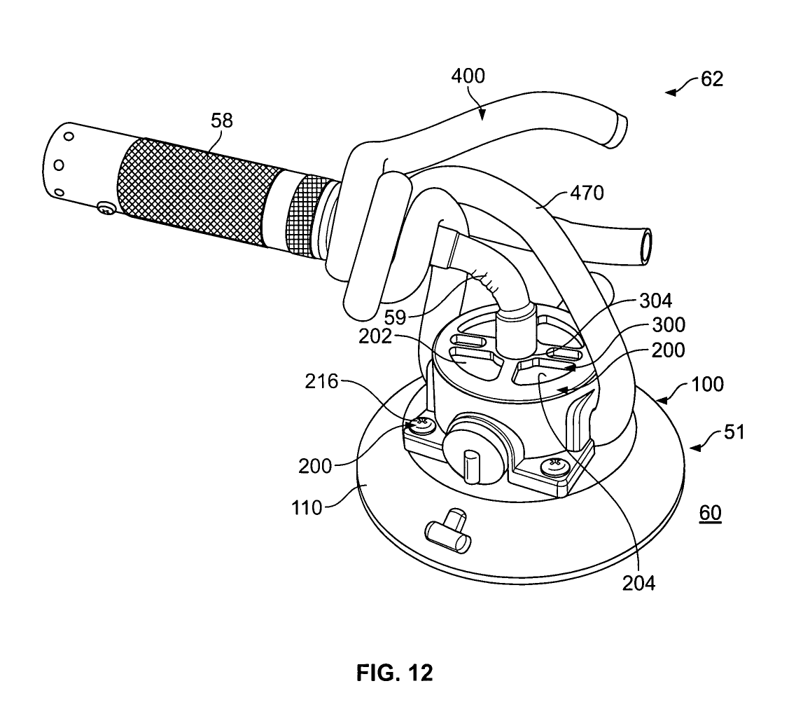

As shown in FIG. 11, the mounting system 60 of FIG. 10 engages with a mounting surface 44 such that the bendable support elements 470 can be manipulated to hold any type of accessory, here a fishing pole 54 and gaff 56. FIG. 12 illustrates another application of the mounting system 60 of FIG. 10. A light accessory 58 with extension 59 is secured to attachment aperture 304 on the top face 204 of housing 202. Extension 59 is pliable to allow for various arrangements of light accessory 58. Bendable support elements 470 provide additional stability to the light accessory 58.

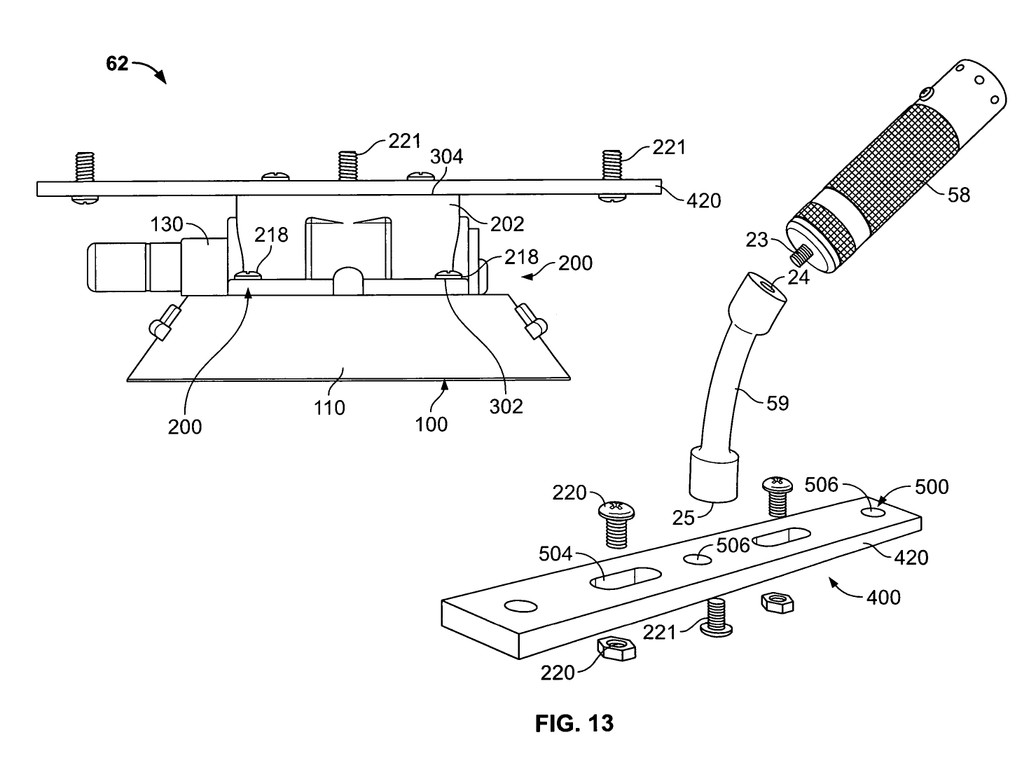

FIG. 13 illustrates another embodiment of a mounting system 62 comprising a vacuum device 100, a securing element 200, a securing element 200 with receiving element 300 and further a support element 400 with connecting elements 500. Vacuum pad 110 and vacuum pump 130 are integrated by housing 202. Screws 218 engage with housing apertures 302 to secure the vacuum pad 110 and vacuum pump 130. Plate 420 includes plate openings 504 and component openings 506. Plate 420 is connected to housing 202 such that attachment apertures 304 on housing 202 align with a with plate openings 504. Fasteners 220, here nuts and bolts, secure the plate 420 to the housing 202. Component fasteners 221 are threaded through component openings 506 such that accessories can be secured to these fasteners 221. As shown, extension 59 of light accessory 58 is secured to fasteners 221. Light accessory 58 includes a male adaptor 23 that is received within a female adaptor 24 of extension 59. Female adaptor 25 receives component fasteners 221 for securing of the accessory to the plate 420. Again, extension 59 is pliable to allow for various arrangements of light accessory 58.

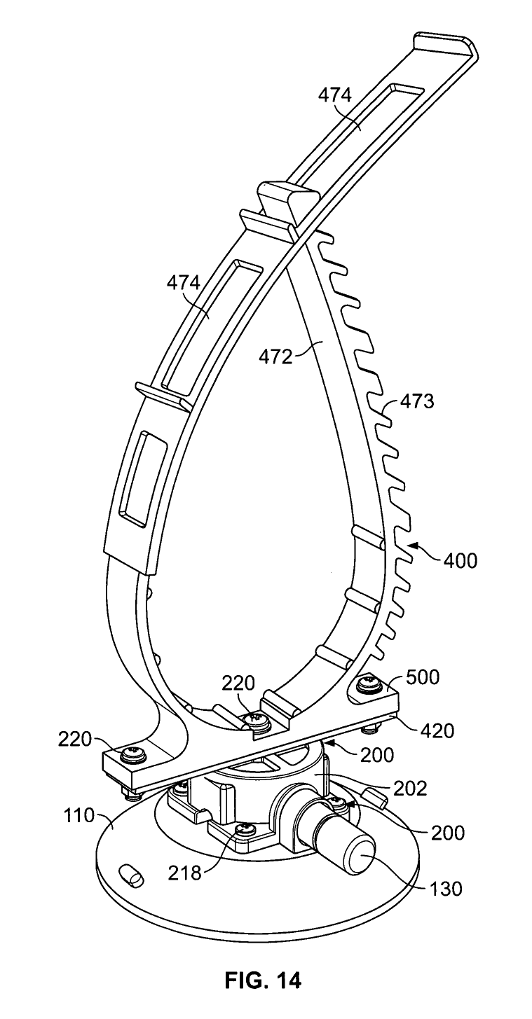

FIG. 14 illustrates another embodiment of a mounting system 64 comprising a vacuum device 100 a securing element 200, securing elements 200 with the receiving element 300 and further a support element 400 with connecting elements 500. Vacuum pad 110 and vacuum pump 130 are integrated by housing 202. Screws 218 engage with housing apertures 302 to secure the vacuum pad 110 and vacuum pump 130. Plate 420 includes plate openings 504 (not shown) and component openings 506 (not shown). Plate 420 is connected to housing 202 such that attachment apertures 304 on housing 202 align with plate openings 504. Fasteners 220, here nuts and bolts, secure the plate 420 to the housing 202. Likewise, fasteners 220 secure strap 472 to plate 420 and in turn to housing 202. As shown, strap 472 includes an open rack 474 and plurality of ratchets 473. Ratchets 473 engage with rack 474 such that strap 472 surrounds an accessory for securement.

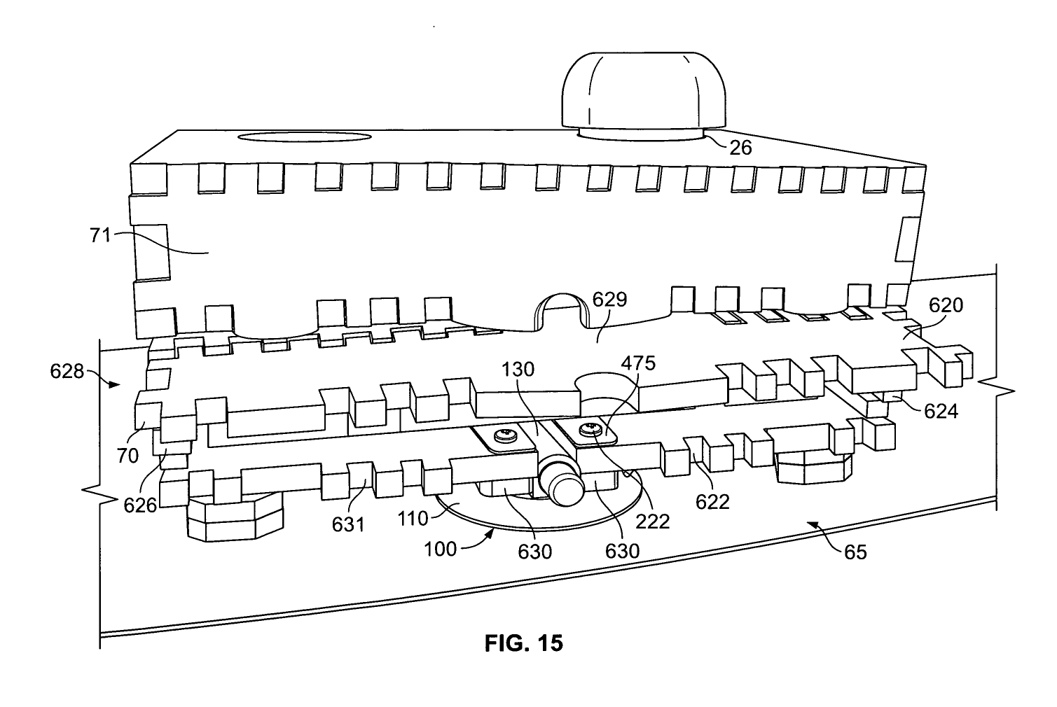

With reference now to FIG. 15, the mounting system 65 comprises the vacuum device 100, including vacuum pad 110 and vacuum pump 130, attached to a first tray 70 in which a tackle box is inserted. The first tray 70 consists of a top portion 620, a bottom portion 622, a first side portion 624, a second side portion 626, a back portion 628 (not visible in this illustration), and a front portion 629. The bottom portion 622 also has feet 630 to support the bottom portion 622 and to provide space for the vacuum device 100.

The portions 620, 622, 624, 626, 628, and 629 may be formed of a foam or sponge product having finger joint portions 631 along the periphery of the portions 620, 622, 624, 626, 628, and 629. The finger joint portions 631 allow the portions 620, 622, 624, 626, 628, and 629 to be locked together and also allow the portions 620, 622, 624, 626, 628, and 629 to be easily separated from each other to store or transport the first tray 70. The portions 620, 622, 624, 626, 628, and 629 may also include other cut out portions of various shapes and sizes. The front portion 629 is adapted to be closed to secure a tackle box within the tray 70 as may be required.

The first tray 70 is attached to the vacuum device 100 by placing feet 630 over pad 110. The bottom portion 662 of tray 70 is positioned over the feet 630 and screws 222 secure clamp 475 for attachment of the tray 70 to the vacuum device 100.

FIG. 15 also illustrates a second tray 71 is shown being placed or stacked on top of the first tray 70. Numerous methods are contemplated for combining the second tray 71 with the first tray 70. As an example, the top portion 620 of the first tray 70 includes a female cutout into which a male projection of the second tray 71 is received. The second tray 71 is constructed in a similar manner and with similar components as the first tray 70. However, the second tray 71 is not connected to the mounting cup device 71.

It is also contemplated that the first tray 70 and second tray 71 include cutouts for accepting various other items. The cutouts can be of any size or shape to accommodate various other accessories, for example, beverages, waterproof cases, lure tubes, etc. For example, as shown in FIG. 15, top portion 620 of first tray 70 includes a cutout 26 to accommodate a can, cup, bottle, or other item. As another example, side portions 624, 626 of first tray 70 includes a cutout 27 (not shown) for lure storage systems such as lure tubes and tackle bags.

In operation, a fisherman may construct the first and second tray 70, 71 by connecting all of the portions together by use of the finger joints to form the trays 70 and 71. The vacuum device 100 is then used to secure the trays 70, 71 to the surface of a water vessel, for example, top of the console or gun whale. Tackle boxes are inserted into each of the trays 70, 71. When the fisherman is done, the tackle boxes may be removed from the trays 70 and 71. The trays 70, 71 may be disassembled for storage or transportation. It is also possible and contemplated that the mounting system 65 may have more than two trays 70, 71. For example, the mounting system 65 may have two or more trays stacked upon the first tray 70. In this manner more than two trays may be employed with the mounting system 65.

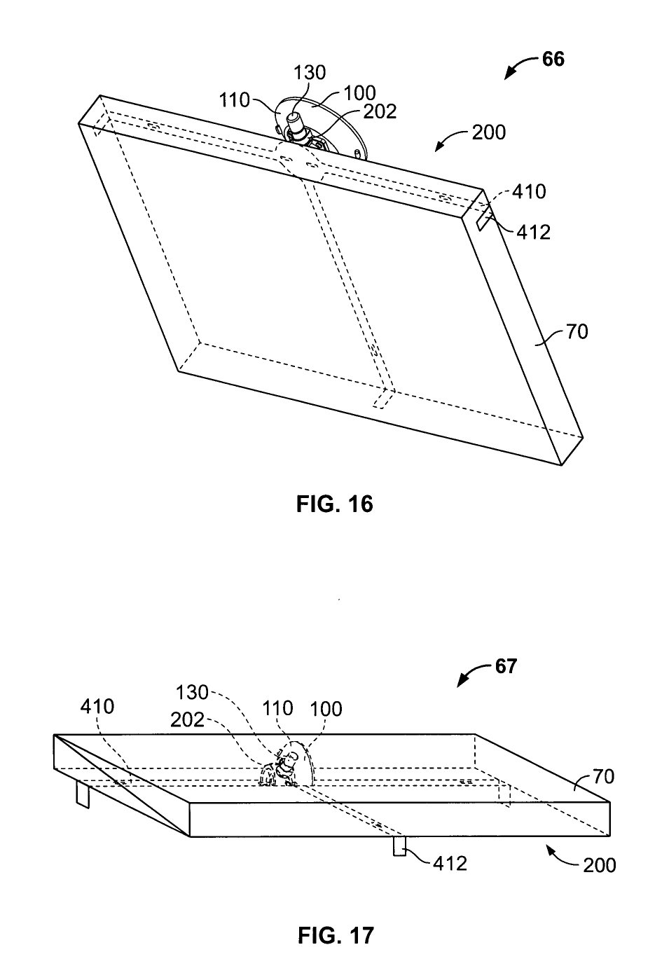

The tray 70 can also be secured to vacuum device 100 through a support element 400. The T-shaped brace 410 as shown in FIG. 3 allows for a vertical and horizontal configuration of the tray 70 as shown in FIG. 16 and FIG. 17. Securing elements 200 connect the slotted connecting elements 502 of the brace 410 with attachment apertures 304 of housing 202. FIG. 16 illustrates a mounting system 66 wherein the T-shaped brace 410 is attached to housing 202 such that tray 70 is positioned within legs 412 for a vertical mount. FIG. 17 illustrates a mounting system 67 wherein the T-shaped brace 410 is attached to housing 202 such that tray 70 is positioned on top of legs 412 for a horizontal mount.

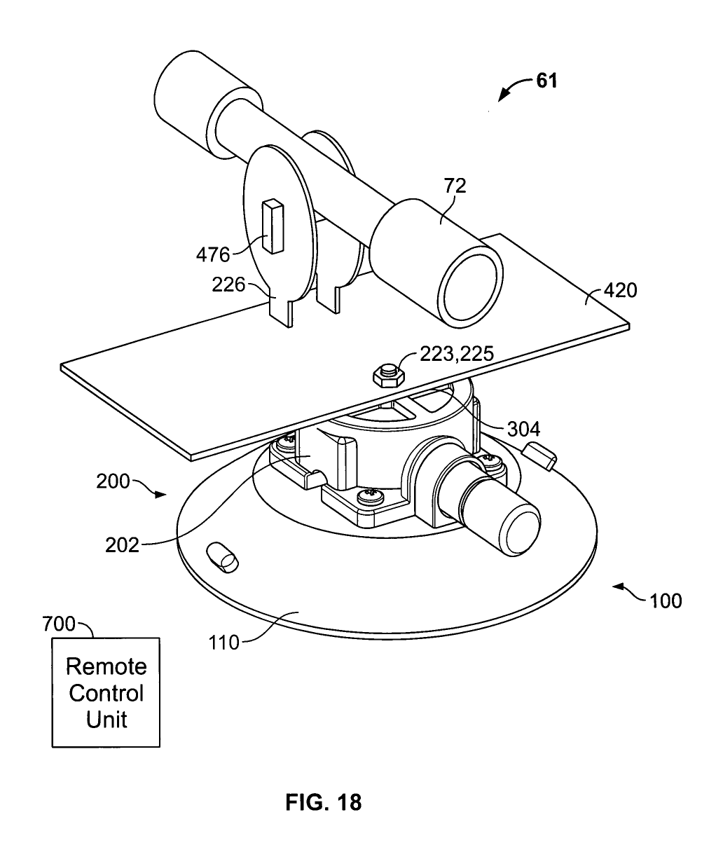

With particular reference now to FIG. 18, mounting system 61 depicts another preferred embodiment of a vacuum device 100 according to the present invention. The mounting system 61 is used to hold or secure a light to a boat for safely boating at night. The mounting system 61 comprises a vacuum device 100 securing element 200, securing element with receiving element 300, and support element 400 with connecting element 500. The plate 420 is mounted to the vacuum device 100 by use of a bolt 223 threaded onto a stud 225. The bolt 223 and stud 225 connects the plate 420 to attachment apertures 304 of housing 202. A light accessory 72 is mounted to another stud 226. The light accessory 72 is housed in a ball socket holder 476. The mounting system 61 includes a remote control device 700 that is used to receive signals from a remote control transmitter (not shown). The remote control device 700 is used to turn the light accessory 72 on and off as needed.

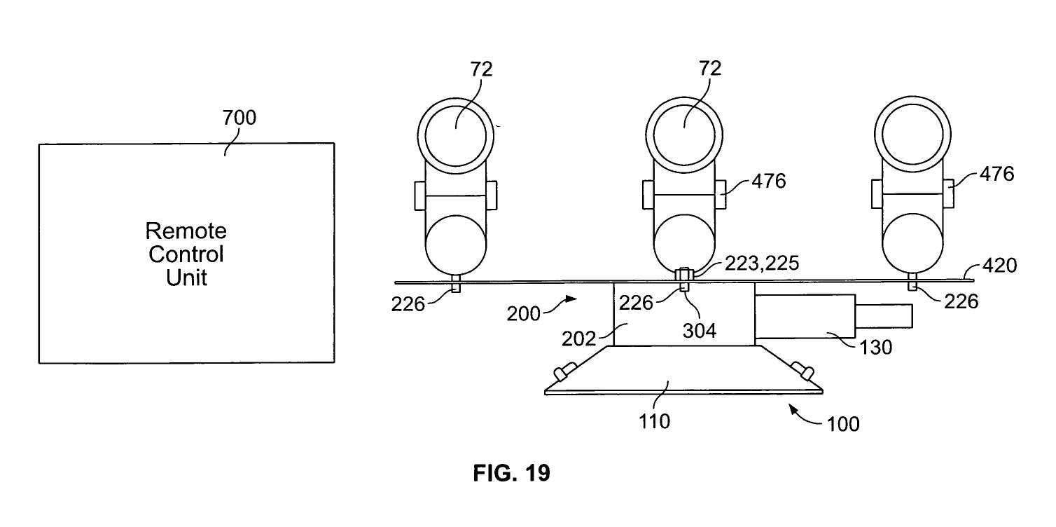

As can be appreciated, the mounting system 61 may be positioned on a boat wherever a light is needed. For example, the mounting system 61 may be mounted to the bow of the boat. When the light accessory 72 needs to be turned on, a signal, such as a radio frequency signal, is sent from a remote control transmitter to the remote control device 700 that controls power to the light accessory 72. The light accessory 72 may be a high-powered flashlight. It is also possible to mount more than one light accessory 72 to the plate 420 as shown in FIG. 19. Also, more than one mounting system 61 may be attached to a boat to provide light for the boat. The mounting system 61 may be easily removed from the bow of the boat and repositioned to other areas of the boat. For example, once the boat is in a position for fishing at night the mounting system 61 may be moved to the center console of the boat to light up the interior of the boat for fishing. Although not shown, a removable cover such as a red filter may be used with the mounting system 61 for night vision work.

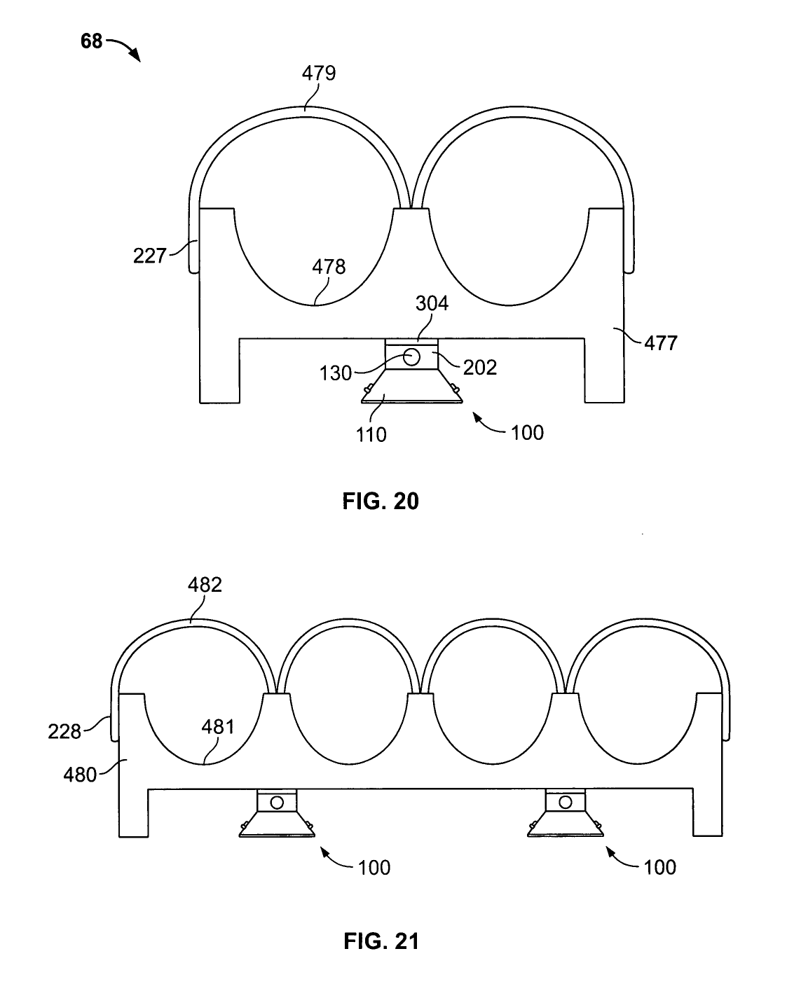

FIG. 20 illustrates another preferred embodiment of a mounting system 68. The mounting system 68 is used to hold or secure a pair of dive tanks (not shown). The mounting system 68 comprises a vacuum device 100 connected to a plane 477. The plane 477 may be manufactured from starboard. The plane 477 has a pair of semi-circular cutouts 478 that are sized and shaped to hold a pair of dive tanks. Straps 479 associated with the cutouts 478 are used to further secure a dive tank in place. The strap 478 has hook and loop fasteners 227 to secure the strap 479 to plane 477. Plane 477 is connected to attachment apertures 304 of housing 202 by securing element 200, such as a nut and bolt.

In operation, the mounting system 68 is placed on the deck of the boat and the vacuum device 100 is engaged to hold the mounting system 68 in place. Dive tanks are placed in the cutouts 478 and the respective straps 479 are secured in place about the dive tanks. The fasteners 227 are used to hold the straps 479 in place.

FIG. 21 illustrates another embodiment of a vacuum device 100 including securing element 200, securing element 200 with receiving element 300, and support element 400 with connecting element 500. The mounting system 69 is used to hold or secure a plurality of dive tanks (not shown). The mounting system 69 comprises two vacuum devices 100 connected to a plane 480. The plane 480 may be manufactured from starboard as mentioned above. The plane 480 has four of semi-circular cutouts 481 that are sized and shaped to hold a plurality of dive tanks. Strap 482 associated with the cutouts 481 is used to further secure a dive tank in place. Strap 481 has hook and loop fasteners 228 to secure the strap 481 in place. Straps 482 are associated with the cutouts 481 and are used to hold a dive tank when a dive tank is placed in the cutout 481.

In operation, the mounting system 69 is placed on the deck of the boat and the vacuum devices 100 and 204 are engaged to hold the mounting system 69 in place. Dive tanks are placed in the cutouts 481 and the respective straps 482 are secured in place about the dive tanks.

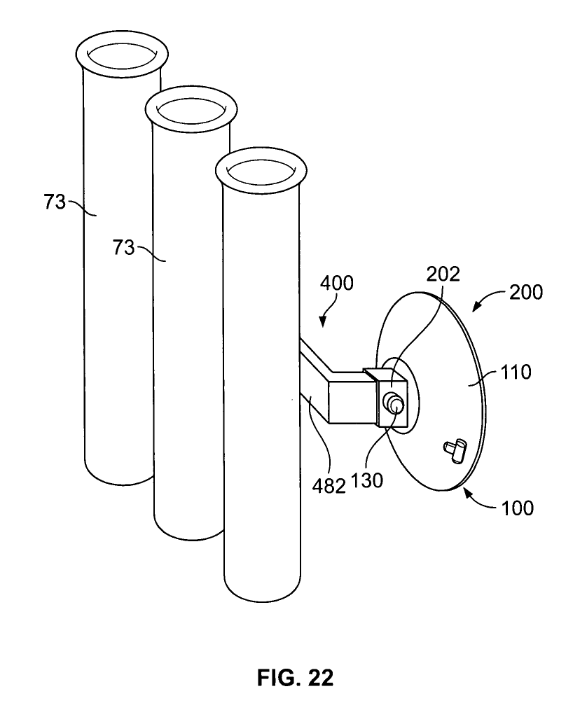

FIG. 22 illustrates another embodiment of a mounting system 80 comprising a vacuum device 100, securing element 200, securing element 200 with receiving element 300 and further a support element 400 with connecting elements 500. Vacuum pad 110 and vacuum pump 130 are integrated by housing 202. Track 479 includes track openings 512 that align with attachment apertures 304 of housing 202. Screws 229 secure track openings 512 with housing 202. Track 482 allows a variety of components to be attached thereto. Components slideably engage on track 482. A rod holder 73 slides onto track 479. This embodiment of the present invention allows a plurality of rod holders 73 to slide onto track 479 as shown in FIG. 22.

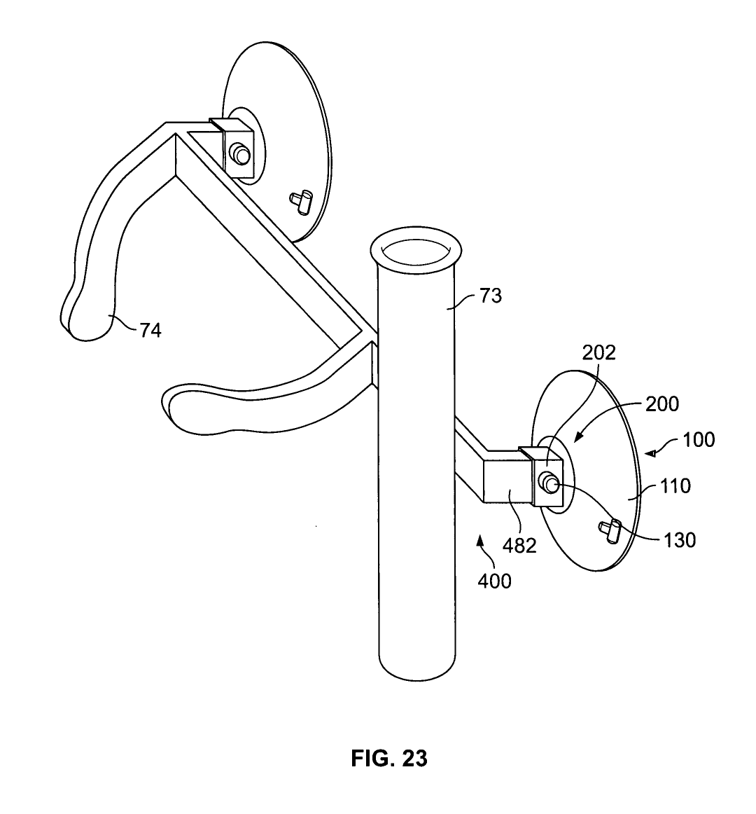

FIG. 23 illustrates various other components slideably engaged on track 482. Again, vacuum pad 110 and vacuum pump 130 are integrated by housing 202. Track openings 512 align with attachment apertures 304 of housing 202. Screws 229 secure track openings 512 with housing 202. Dive tank holder 74 slideably engages on track 482 along with rod holder 73.

Track 482 allows for numerous support elements 400 to slideably engage thereon. For example, multiple rod holders 73, dive tanks 74 or a combination thereof. It should also be noted that rod holders 73 and dive tanks 74 can be attached directly to the housing 202.

Housing 202 allows accessories to be directly attached to the attachment apertures 304, for example a rod holder, cleat, marker buoy, radar and portable electronic device. The accessories can be directly attached to the housing 202 through the use of hardware secured to the attachment apertures 304 or the accessories can be attached to the top side 204 of housing 202 through the use of a hook-and-loop fastener, e.g., Velcro®.

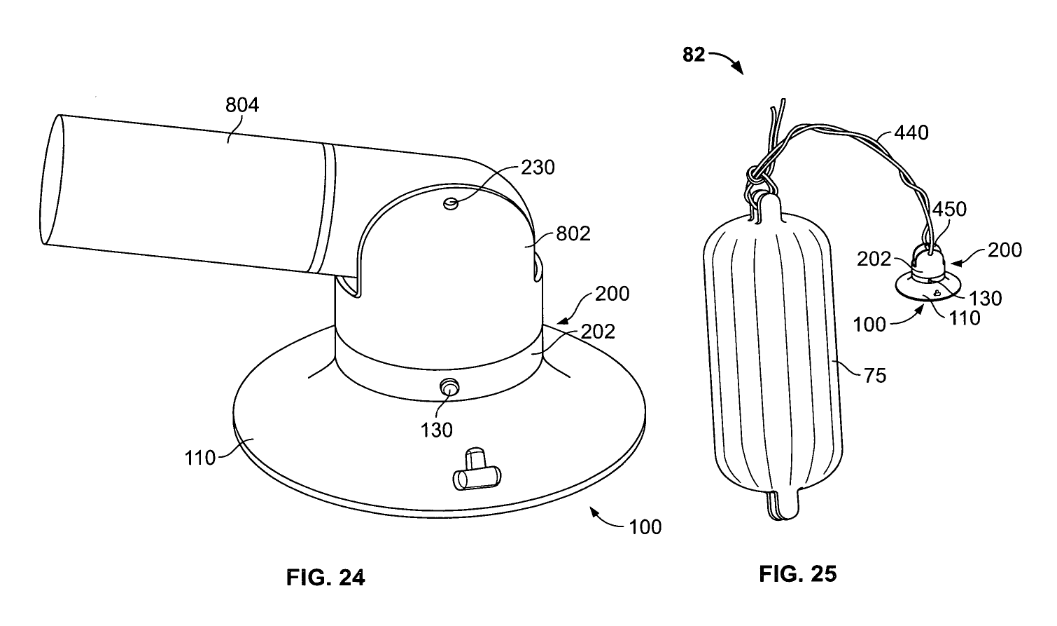

FIG. 24 illustrates another embodiment of a mounting system 81 comprising a vacuum device 100 with securing elements 200. Vacuum pad 110 and vacuum pump 130 are integrated by housing 202. A swivel mount 802 is connected to attachment apertures 304 of housing 202. A rocker mount 804 is attached to the swivel mount 802 via a pin securing element 230. This mounting system 81, or “rod rocker”, is an improvement over gimbal mounts. A gimbal mount is a device attached to a fighting chair for insertion of a rod when fighting a fish, and allows the rod to swivel in multiple directions following the movement of the fish. The rocker mount 804 allows a rod positioned in the “rod rocker” to rock in multiple directions while the swivel mount 802 allows the rod to rotate in a full circle, or 3600, without the need for the fighting chair. Additionally, a rod can be placed within the swivel mount 802 on top of pin 230, thereby eliminating the need for the rocker mount 804. The mounting system 81 can then be adhered to the surface of a water vessel and a fishing rod can be placed in the rod rocker.

FIG. 25 illustrates another embodiment of a mounting system 82 comprising a vacuum device 100, securing element 200 and support element 400. Housing 202 integrates vacuum pad 110 with vacuum pump 130 via securing elements 200 such as screws attached through housing apertures 302. Handle 450 snap fits to housing 202 and rope 440 connects to handle 450. This mounting system 82 allows any component to be secured to rope 440, here, a buoy 75.

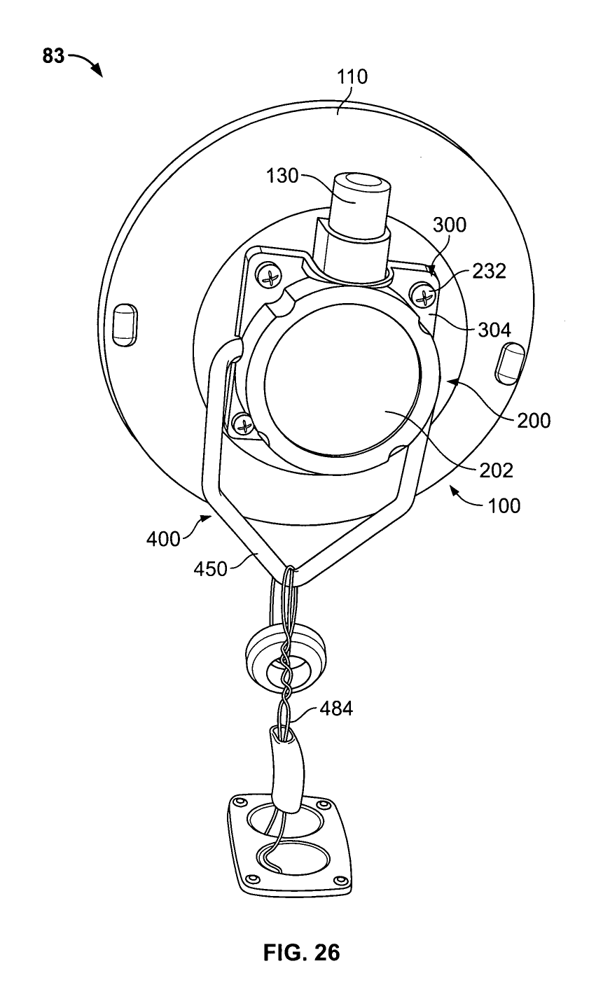

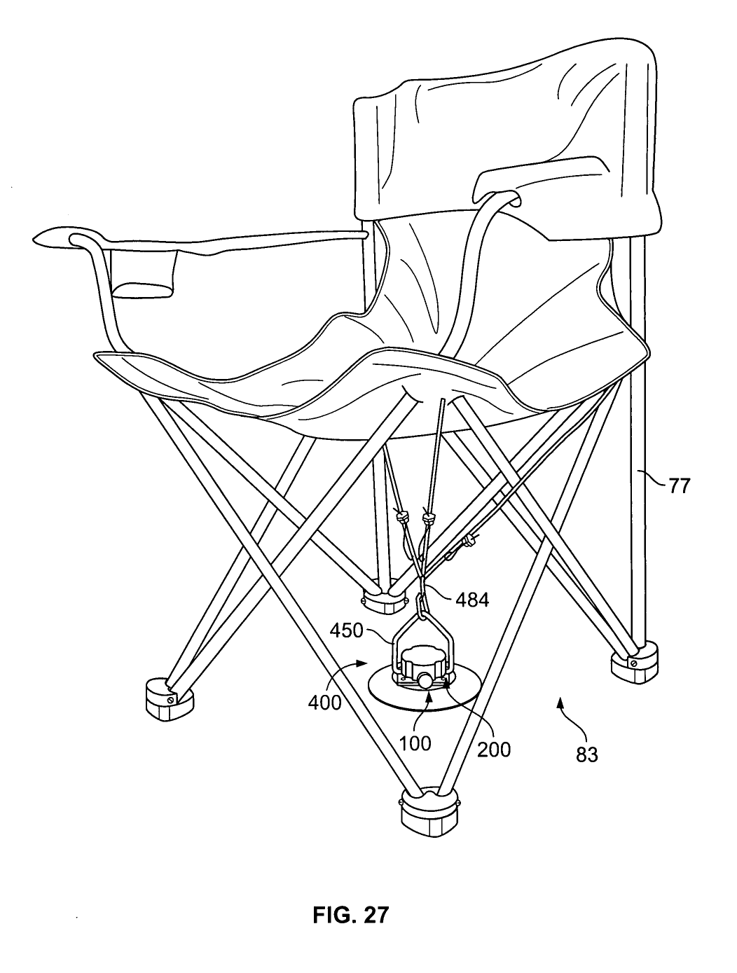

FIG. 26 illustrates another embodiment of a mounting system 83 comprising a vacuum device 100, securing element 200, securing element 200 with receiving element 300, and support element 400. Housing 202 integrates vacuum pad 110 with vacuum pump 130 via screws 232 attached through housing apertures 302. Handle 450 snap fits to housing 202 and cable 484 connects to handle 450. Cable 484 includes a nut and bolt cable lock, and swivel snap. Cable 484 can be adjusted to any desirable length. This mounting system 83 can be used to secure folding chairs to the deck of a boat, as well as buckets or bait coolers. Cable 484 can be secured, for example, from under a chair or bucket handle to under the gunnels to lock down a device that would not normally be lockable. Likewise cable 484 keeps a vacuum device 100 in position in the event the pad 110 disengages from surface.

FIG. 27 illustrates the mounting system of FIG. 26 with a folding chair 77. Vacuum device 100 is attached to a surface of a water vessel. Cable 484 connects to the chair in order to keep the chair positioned in the event a fisherman is fighting a fish.

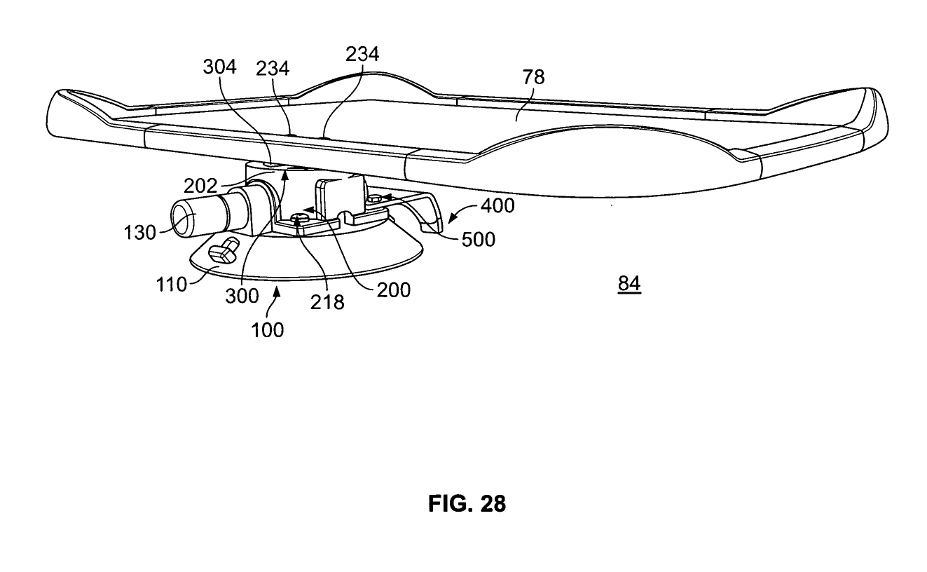

FIG. 28 illustrates another embodiment of a mounting system 84 including the buttress 460 of FIG. 8. Mounting system 84 includes a vacuum device 100, securing element 200, securing element 200 with receiving element 300, and a support element 400 with connecting elements 500. Housing 202 integrates pad 110 with pump 130 and is secured by screws 218 through housing apertures 302. Bait tray 78 connects to attachment apertures 304 of housing 202 via screws 234. Mounting system 84 further includes a buttress 460 as described in reference to FIGS. 8 and 9.

Although a horizontal mount is shown in FIG. 28, the mounting system 84 can be mounted vertically. A support element 400 such as an L-bracket allows vacuum device 100 to be secured to a sidewall of a water vessel while allowing the tray 78 to rest on a surface of a water vessel, for example a gunwale.

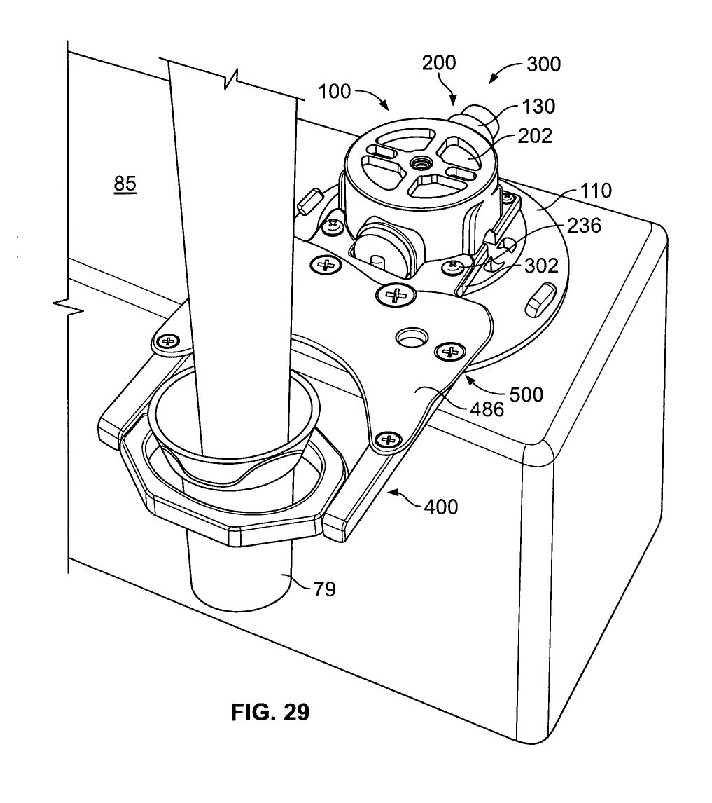

FIG. 29 illustrates another embodiment of a mounting system 85 comprising a vacuum device 100, securing element 200, securing element 200 with receiving element 300, and support element 400 with connecting elements 500. Housing 202 integrates vacuum pad 110 with vacuum pump 130. Bracket 486 is secured to housing apertures 302 of housing 202 via screws 236. Gimbal 79 is secured to bracket 486 via pin to allow gimbal 79 to tilt freely in any direction. This mounting system 85 can be attached to any surface of a water vessel as well as to another accessory, such as a fighting chair.

With all of the above embodiments discussed herein, the vacuum device is adhered to any mounting surface of a water vessel. The securing elements, and likewise the support elements, of the present invention allow for a variety of applications relating to the attachment of accessories to a water vessel.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A system for mounting an accessory to a mounting surface, comprising:
a securing element, wherein said securing element secures the accessory to a vacuum device; and
said vacuum device including a vacuum pad and a vacuum pump and through the application of which a vacuum is developable such that said vacuum device is mountable, and thereby the accessory secured to said vacuum device through said securing element is mountable to the mounting surface.

2. A mounting system for mounting an accessory to a mounting surface, comprising:
a vacuum device including a vacuum pad and a vacuum pump through which a vacuum may be developed between said vacuum pad and the mounting surface;
a support element;
a first securing element, wherein said first securing element secures said support element to said vacuum device; and
a second securing element, wherein said second securing element secures the accessory to said support element.

3. A system for securing an accessory to a mounting surface, comprising:
a vacuum device including a vacuum pad and a vacuum pump through which a vacuum may be developed under said vacuum pad in contact with the mounting surface;
a first securing element including a first receiving element and a second receiving element,
a second securing element wherein said second securing element engages with said first receiving element to integrate said vacuum pad with said vacuum pump;
a support element;
a third securing element wherein said third securing element secures said support element to said second receiving element; and
a fourth securing element wherein said fourth securing element secures said component to said support element.
